(19) United States
(12) Patent Application Publication
(10) Pub. No.: US 2011/0079996 A1
(43) Pub. Date: Apr. 7, 2011

(54) Apparatus and Method for Document Binding

(76) Inventor: David Seid, Phoenix, AZ (US)

(21) Appl. No.: 12/896,693

(22) Filed: Oct. 1, 2010

Related U.S. Application Data
(60) Provisional application No. 61/248,096, filed on Oct. 2, 2009.

(51) Int. Cl. B42D 1/00; B42C 9/00

(52) U.S. Cl. 281/15.1; 412/6

(57) ABSTRACT

The invention presents a book apparatus and a bookbinding method using a book cover with a front cover, rear cover, and a middle portion, bound through the rear cover with two parallel rows of offset cover holes, and a helix coil component configured to hold pages inside the book cover, so the book may lie flat when opened.

### RELATED INVENTION

The present invention claims priority under 35 U.S.C. §119(e) to: “Apparatus and Method for Document Binding,” U.S. Provisional Patent Application Ser. No. 61/248,096, filed 2 Oct. 2009, which is incorporated by reference herein.

### BRIEF DESCRIPTION OF THE DRAWINGS

FIG. 1 is an interior view of the open configuration of a version of the present invention.

FIG. 2 is a perspective view of the closed configuration of a version of the present invention.

FIG. 3 is a back view of the closed configuration of a version of the present invention.

### DETAILED DESCRIPTION

### A. The Apparatus

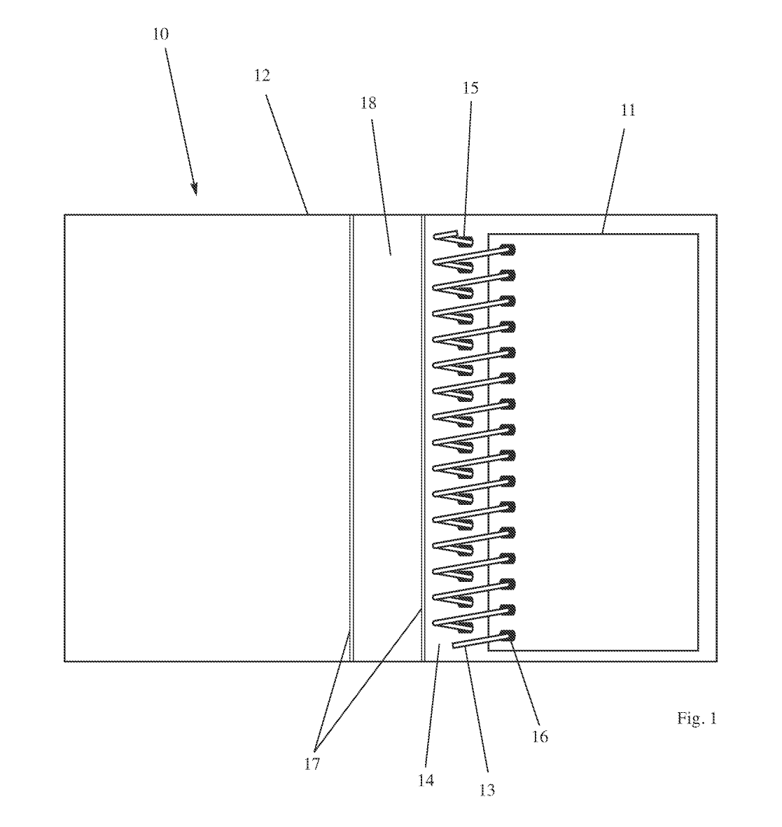

Referring now to the invention in more detail, in FIG. 1 there is shown a book 10 containing pages 11 that are bound to a cover 12 by means of a helix (coil or spiral) component 13. Each of the pages 11 are attached to a single flat surface of the cover 14 by means of the coil (spiral) component 13 inserted through a single row of page holes 16 cut through the pages 11 and through two parallel rows of offset cover holes 15 (of which one row is visible in this view) that are cut through the cover 12 that is shown with hinge points 17 for folding around the helix (coil or spiral) component 13 to form a cased-in (self) cover 12.

In more detail, still referring to the invention of FIG. 1, the pages 11 of the book 10 as shown are bound to the back surface 14 of the cover through two parallel rows of offsetting cover holes 15 (of which one row is visible in this view.)

In further detail, still referring to the invention of FIG. 1, the two parallel rows of cover holes 15 (of which one row is visible in this view,) are parallel to the spine 18 of the book 10.

In further detail, still referring to the invention of FIG. 1, the two parallel rows of cover holes 15 (of which one row is visible in this view,) are offset from one another.

In further detail, still referring to the invention of FIG. 1, the book when opened lays flat on a work surface, table, podium or other generally flat surface.

The construction details of the invention as shown in FIG. 1 are that the book 10 may be bound with a varying quantity of pages 11 of varying materials such as paper, plastic, veneers and the like. Further, the sizes of the pages 11 can vary.

In more detail, still referring to the construction details of the invention as shown in FIG. 1, are that the pages 11 may be bound with a helix (coil or spiral) component 13 of varying materials such as metal, plastic, composites and the like.

In more detail, still referring to the construction details of the invention as shown in FIG. 1, are that the cover 14 may be of varying size to match the size of pages or be of smaller or larger sizes.

In more detail, still referring to the construction details of the invention as shown in FIG. 1, are that the cover 14 may be hinged for folding around the helix (coil or spiral) component 13 or may consist of a single flat surface 14 that is not scored for folding or creating a spine 18.

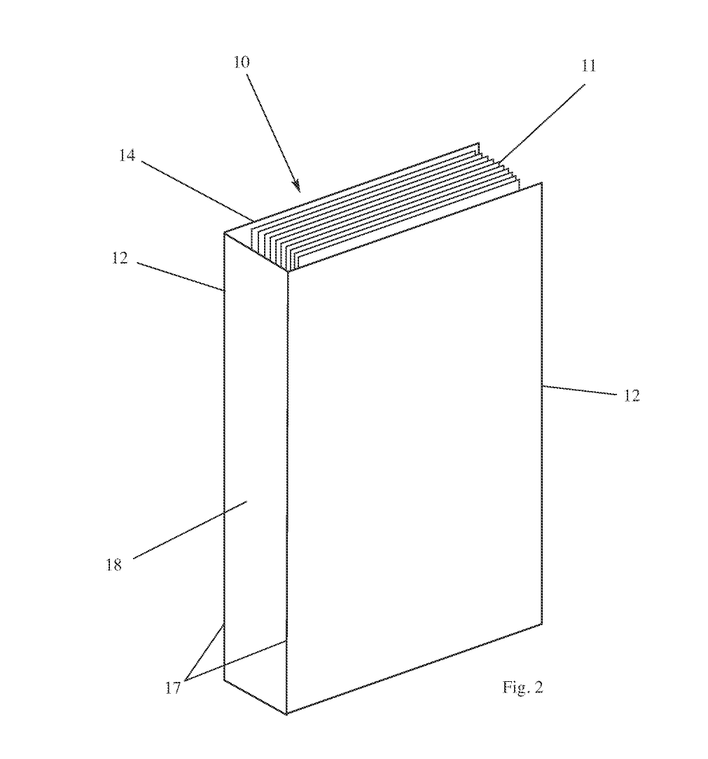

Referring now to the invention in more detail, in FIG. 2 there is shown a book 10 containing pages 11 that are bound to a cover 12.

In more detail, still referring to the invention of FIG. 2, the book 10 as shown is closed with the spine 17 and front cover 18 wrapping around the coil (spiral) component which in this view is concealed.

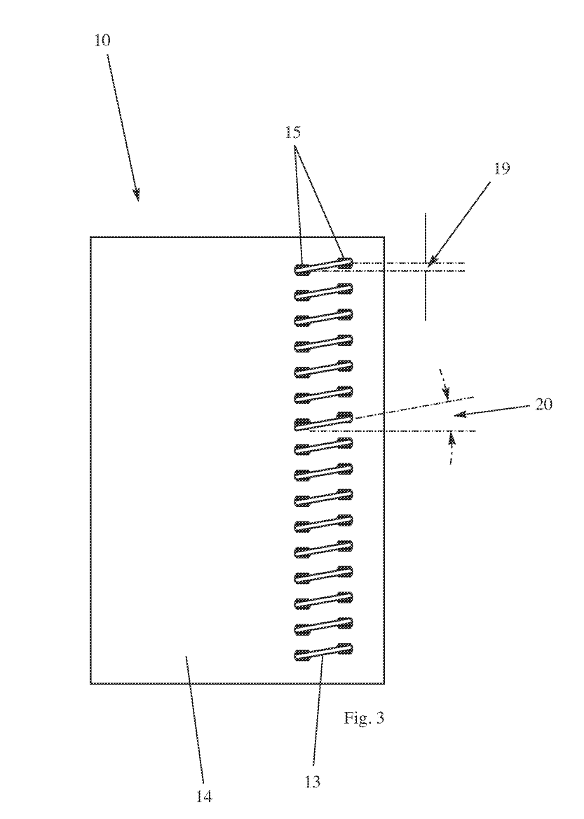

Referring now to the invention in more detail, in FIG. 3 is shown two parallel rows of cover holes 15 of which each row is offset 19 to the other and which both rows are punched, die-cut or similarly made through a single flat surface of the cover 14.

In more detail, still referring to the invention of FIG. 3, are that the two parallel rows of cover holes 15 are offset from one another by a variable that corresponds to the angle 20 of the helix (coil or spiral) component 13 so that the helix (coil or spiral) component 13 is not subject to torque.

The construction details of the invention as shown in FIG. 3 are that the holes 19 may be of varying size, shape and the like.

In more detail, still referring to the construction details of the invention as shown in FIG. 3 are that the holes 19 of each parallel row may be set apart by varying dimension to accommodate varying sizes of helix (coil or spiral) component 13.

In more detail, still referring to the construction details of the invention as shown in FIG. 3 are that the single flat surface 14 onto which pages are attached may be of varying size, shape and use, such as a cover, a self-cover, a backing, a support or the like.

The advantages of the present invention include, without limitation, that the helix (coil or spiral) component when inserted to two rows of offset holes that correspond to the angle of the helix (coil or spiral) cut in a flat surface will not be subject to torque and will remain aligned with the two rows of parallel holes.

Further, the advantages of the present invention include, without limitation, that books, workbooks, manuals, flip charts, and similar materials comprised of pages bound to a cover, multiple covers, a flat surface or multiple flat surfaces in this method will lay flat when opened fully.

Further, the advantages of the present invention include, without limitation, that covers hinged to form a cased-in (self) cover in this method will permit imprinting or similar identification on the spine or cover without interference by the helix (coil or spiral) binding component.

### B. The Method

In broad embodiment, the present invention is a binding method for helix (coil or spiral) components that permits attaching pages or flat sheets to flat surfaces using two rows of parallel holes that are offset to one another.

A binding method involves cutting two rows of offset holes into the backing or self-cover of a book for the purpose of holding a coil (spiral helix) wire to bind pages of a book to the cover. The two rows of offset holes are a unique feature that permits the coil (spiral helix) wire, made of metal, plastic, or other composites, to be held in alignment with the spine of the book. A self-cover may also wrap around the coil (spiral helix) of a finished book so that imprinting may be applied to the spine for the purpose of being able to know the title or other identifying features of a book when it is archives on a shelf, in a stack or in another type of file where the front cover may be concealed, lying against another book or otherwise not able to be seen visually.

Traditional methods of attaching backings or self-covers in binding books using wire have utilized twin loop wire. The advantages of coil (spiral helix) wire is that it uses less material and is commonly available in more colors, material choices (e.g., plastics and recycled materials) and has a different aesthetic to that of the twin loop wire method. Advantages of binding books (i.e., booklets, manuals, workbooks, guide books, etc.) using a coil (spiral helix) wire binding are that the book lays flat when opened and pages may be easily customized as single sheet insertions using a variety of printing and demand printing methods.

A disadvantage of coil (spiral helix) wire binding is that a self-cover has not been an option due the fact that die-cutting dies and machinery for cutting two rows of holes has been engineered solely for twin loop type wire binding components, of which the two rows of holes are not offset, but configured so that each row of holes is directly opposite one another and perpendicular to the alignment of the rows of holes. The unique cutting method requires cutting holes in any number of methods (e.g., die-cutting, punching, laser cutting or by other methods) so that each row is offset and matches the angle of the helix of the coil (spiral helix) to be used to hold pages onto the backing or self-cover.

The primary advantages of the invention are:
That coil (spiral helix) wire may be used to bind flat sheets (pages) to a backing or self-cover, enabling the backing or self-cover to extend past the coil (spiral helix) for form a wrap-around cover or other form of specialized cover or backing Such uses include books, booklets, manuals, workbooks, flip-charts or other forms of binding flat sheets to backings or covers.
Coil (spiral helix) wire is available in more varieties (colors, materials, recycled materials and options) than other wire binding types, such as twin loop wire.
A self-cover that wraps around allows for imprinting on the spine, concealing the coil (spiral helix) wire when the bound item is displayed on a shelf, in a file or other configuration where only the spine may be seen. This permits locating and visibility of the title, name or other identifier which has traditionally not been accommodated with coil (spiral helix) binding methods due to the fact that the angle of the helix was not accommodated in two rows of binding holes that were not offset from each other.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A book apparatus, comprising a three-section book cover, whose sections are front cover, rear cover, and a middle portion, wherein the rear cover has two parallel rows of offset cover holes, a helix coil component holds pages inside the book cover on the rear cover through the two parallel rows of offset cover holes, so the book may lie flat when opened.

2. A method of binding a book, comprising, selecting a book cover whose sections are front cover, rear cover, and a middle portion, wherein the rear cover has two parallel rows of offset cover holes, binding the book with a helix coil component configured to hold pages inside the book cover on the rear cover through the two parallel rows of offset cover holes, so the book may lie flat when opened.
